(19) United States
(12) Patent Application Publication
(10) Pub. No.: US 2023/0313042 A1
(43) Pub. Date: Oct. 5, 2023

(54) WETTING AGENT COMPRISING AT LEAST ONE FATTY ACID MONOGLYCERIDE

(71) Applicant: OLEON NV, Evergem (Ertvelde) (BE)

(72) Inventors: Sophie DEPREY, Margny-les-Compiegne (FR); Sylvie HERY, Jaux (FR); Pieter VAN DER WEE?N, Gent (BE)

(21) Appl. No.: 18/006,338

(22) PCT Filed: Jul. 21, 2021
(86) PCT No.: PCT/EP2021/070437

§ 371 Date: Jan. 20, 2023

(30) Foreign Application Priority Data
Jul. 22, 2020 (FR) FR2007702

(51) Int. Cl. C09K 17/14; A01N 25/02

(52) U.S. Cl. CPC C09K 17/14; A01N 25/02; A01P 15/00

(57) ABSTRACT

The present invention relates to a combination comprising caprylic acid monoglyceride, at least one mannosylerythritol lipid and monopropylene glycol, to a method for obtaining same and to the use thereof as a wetting agent, in particular as a soil wetting agent. The invention also relates to solutions comprising such a combination.

### TECHNICAL FIELD

The present invention relates to a combination comprising a fatty acid monoglyceride, at least one mannosylerythritol lipid and monopropylene glycol, the process for obtaining it and its use as a wetting agent, in particular as a soil wetting agent. The invention also concerns solutions comprising a combination according to the invention.

Global warming and periods of drought mean that soils are increasingly short of water and dry.

By “soil” is meant the upper part of the earth’s crust, constituted by mineral matter (sand, clay and/or silt), organic matter, air and water, in which plants are able to grow.

Soils include agricultural ground, such as for fruit, ornamental, cereal, vegetable and/or oleaginous crops, and green spaces such as golf courses, sports grounds, gardens and parks.

The dryness of the soil gives rise to hardening thereof and an increase in its hydrophobicity, making it increasingly difficult to absorb water. Water runoff occurs which may include nutritive components for plants, insecticides, fungicides and/or herbicides, which not only leads to an increased loss in productivity of the crops which no longer receive the components intended for their proper growth, but may also be dangerous for humans and the environment if such potentially toxic components end up in surface water reservoirs.

Furthermore, the dryness of the soil may give rise to excessive water consumption to re-establish sufficient moistening of the soil and avoid losses in yield and/or the death of the plants.

By “plant” is designated any member of the “Plantae” kingdom, whatever its stage of development such as seed, bulb, seedling or adult plant.

In order to avoid these problems, wetting agents are used in irrigation water, in particular soil wetting agents, to promote the absorption of the water by the soil.

Wetting agents reduce the surface tension of the water thereby facilitating the spreading of aqueous solutions comprising them over a solid hydrophobic surface.

Soil wetting agents facilitate the absorption of an aqueous solution into the soil, by enabling that solution to spread and cover the solid hydrophobic particles constituting the soil.

Therefore, a smaller quantity of water is required to attain proper moistening of the soil favorable to plant growth.

### PRIOR ART

Numerous wetting agents currently on the market are ethoxylated alcohol based polymers. The manufacture of these products is not without danger and they may even present a degree of toxicity.

An alternative solution that is accepted in organic farming has been developed based on extract of Yucca Schidigera (Therm X-70 from American Extracts). However, this product is nevertheless labeled as an irritant for the eyes (H320). There is therefore still a need for a wetting agent, in particular for the soil, that is harmless to humans and environmentally friendly.

### DISCLOSURE OF THE INVENTION

The work by the inventors has made it possible to show that a combination of a fatty acid monoglyceride, at least one mannosylerythritol lipid and monopropylene glycol, solubilized very well in water and remained stable at ambient temperature while increasing the wetting power of the water, when the combination was added thereto, such that its use as a wetting agent would be particularly advantageous. Furthermore, soil that has been placed contact with such a combination more easily absorbs water persistently. As a matter of fact, not only is the soil placed in contact with the combination according to the invention capable of absorbing a greater quantity of water (at least 5, preferably at least 7 times more water than soil not placed in contact with the combination according to the invention), but the soil is also capable of absorbing the same quantities of water at the time of the at least 3, preferably at least 5, more preferably at least 9 additions of water following placing the soil in contact with the combination according to the invention.

The invention thus relates to a combination comprising or consisting of:
caprylic acid monoglyceride;
at least one mannosylerythritol lipid;
monopropylene glycol; and
optionally a fatty acid and/or a fatty acid ester;
wherein the total quantity of caprylic acid monoglyceride and mannosylerythritol lipid(s) is at least 20% by weight relative to the weight of the combination.

It is considered by the present application that the term “consisting of” includes for example in particular the by-products and impurities of the compounds of the combination. However, this term (equivalent to “constituted by”) excludes the presence of any other additional compound.

By “impurities” is meant compounds of which the presence is indicated by a purity of the product of interest of less than 100%.

By “by-products” is meant compounds that participate in obtaining or result from obtaining the product of interest. For example the mannosylerythritol lipid(s) may be obtained in a mixture with at least one fatty acid and/or at least one fatty acid ester.

It is understood that impurities may also be by-products and vice-versa. Caprylic acid monoglyceride (MG-C8) is also called glyceryl caprylate. Monopropylene glycol (MPG) is also called propylene glycol or propane-1,2-diol. By “mannosylerythritol lipid” or MEL is meant a surfactant comprising a hydrophilic part formed by the mannosylerythritol group, and a hydrophobic part formed by at least one acyl group.

By MEL is designated more particularly a chemical substance having the following general formula represented by chemical formula 1:

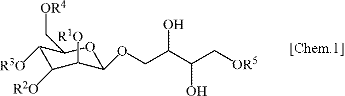

wherein:
R¹ and R², which may be identical or different, represent an acyl group, comprising an unsaturated or saturated acyclic carbon chain,
R³ and R⁴, which may be identical or different, represent an acetyl group or a hydrogen atom, and
R⁵ represents a hydrogen atom or an acyl group.

Among the MELs represented by chemical formula 1 described above, the “di-acylated MELs” may be distinguished from the “tri-acylated MELs”, according to the nature of the group present at R5. It will be noted that according to this terminology, the acetyl groups that may be present at R³ and R⁴ are not counted in the acyl groups.

By tri-acylated MEL is designated a chemical substance represented by chemical formula 1 wherein R¹, R², R³ and R⁴ are as indicated above and R⁵ represents an acyl group.

By di-acylated MEL is designated a chemical substance represented by chemical formula 1 wherein R¹, R², R³ and R⁴ are as indicated above and R⁵ represents a hydrogen atom.

A di-acylated MEL is thus represented by the following chemical formula 2:

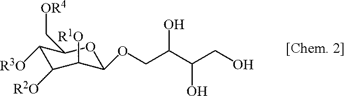

Advantageously, the at least one MEL comprised in the combination according to the invention is di-acylated.

Two stereoisomers of di-acylated MEL represented by chemical formula 2 are known and are represented by the following chemical formulas 3 and 4:

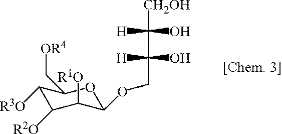

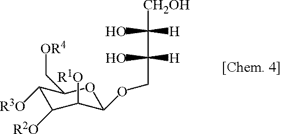

wherein R¹, R², R³, R⁴ are as indicated for chemical formula 1. Advantageously, a di-acylated MEL is a chemical substance represented by chemical formula 3.

Chemical formulas 1 to 4 above may represent several chemical substances, each chemical substance thus being a MEL.

By “MELs” is designated at least two chemical substances represented by chemical formulas 1, 2, 3 or 4 that differ by their substitution (acyl groups, acetylated groups) or by their stereoisomerism, more particularly at least two chemical substances represented by chemical formula 3.

Moreover, MELs are generally classified into four chemical substance classes, denoted A to D, according to their degree of acetylation at R³ and R⁴. The MELs-A class comprises chemical substances represented by chemical formula 1 having two acetyl groups at R³ and R⁴. The MELs-B class and the MELs-C class comprise chemical substances represented by chemical formula 1 having a single acetyl group at R⁴ and R³ respectively. Lastly, the MELs-D comprise chemical substances represented by chemical formula 1 not having an acetyl group (R³═ R⁴═H).

In addition to varying by their degree of acetylation, MELs may vary in their structure, due to the nature of the acyl groups arising from fatty acids which compose their hydrophobic part.

This variation is generally a function of the process implemented to obtain MELs. MELs are generally obtained by processes employing fungal culture, and more particularly that of yeasts.

Advantageously the MELs to which the present application is directed are obtained by a fermentation process, comprising the following steps:
culturing a fungal strain and more particularly a yeast strain in the presence of a carbon source to obtain MELs; and
collecting the MELs so obtained.

The strains from which it is possible to obtain MELs are well-known to the person skilled in the art. By way of example, it is known to use strains of the family Basidiomycetes, preferably of the genus Pseudozyma, such as Pseudozyma antarctica, Pseudozyma parantartica, Pseudozyma aphidis, Pseudozyma rugulosa, Pseudozyma graminicola, Pseudozyma siamensis, Pseudozyma hubeiensis, Pseudozyma tsukubaensis, Pseudozyma crassa, or of the genus Ustilago, such as Ustilago maydis, Ustilago cynodontis and Ustilago scitaminea. In general, according to the strain, one class of MELs (MELs-A, MELs-B, MELs-C or MELs-D), is mainly produced, or even exclusively produced, relative to the other MEL classes. By way of example, Pseudozyma antarctica, Pseudozyma aphidis, Pseudozyma rugulosa and Pseudozyma parantarctica produce a majority of MELs-A represented by chemical formula 3. Pseudozyma graminicola, Pseudozyma siamensis, Pseudozyma hubeiensis produce a majority of MELs-C represented by chemical formula 3. Pseudozyma tsukubaensis produces a majority of MELs-B represented by chemical formula 4 and Pseudozyma crassa produces a majority of MELs-A represented by chemical formula 4.

Advantageously, the MELs are obtained by a fermentation process employing a strain producing MELs of which at least 80%, preferably at least 85% by weight are represented by chemical formula 3.

More particularly, the MELs are obtained by a fermentation process employing a strain selected from Pseudozyma aphidis, Pseudozyma rugulosa, Pseudozyma antarctica or Pseudozyma parantarctica, preferably from Pseudozyma aphidis, Pseudozyma antarctica or Pseudozyma parantarctica, more preferably the strain is Pseudozyma aphidis.

The carbon-containing substrate is typically a glycerol, an n-alkane or an oil, in particular of renewable origin.

Any oil, composed of triglycerides and being liquid at the temperature of the fermentation process, may be used as carbon-containing substrate.

Preferably, the renewable oil is a vegetable or animal oil, more preferably a vegetable oil. In particular, the vegetable oil is selected from the group consisting of soybean oil, sunflower oil, olive oil and rapeseed oil. More particularly, the vegetable oil is a soybean oil or a rapeseed oil, still more particularly, a rapeseed oil.

These renewable oils are particularly rich in acyl groups comprising a carbon chain with 18 carbon atoms, such as the acyl groups arising from oleic, linoleic and/or linolenic acid.

The fermentation process generally takes at least 3 days, preferably at least 7 days.

According to a preferred embodiment, the MELs are obtained by a fermentation process employing:
a strain of the genus Pseudozyma, preferably Pseudozyma antartica, Pseudozyma parantarctica, or Pseudozyma aphidis,
a vegetable oil, preferably a rapeseed oil or a soybean oil, as carbon-containing substrate.

Such a strain is usually grown in a reactor in a growth medium comprising glucose, water and/or salts (such as magnesium sulfate, monopotassium phosphate, sodium nitrate, and/or ammonium nitrate). This growth medium is also employed in the fermentation process. As a matter of fact, in general terms, the fermentation medium of the fermentation process comprises a growth medium and the carbon-containing substrate.

Advantageously, the different components of the fermentation medium (glucose and strain included) are sterilized separately before introduction into the reactor. The temperature of the fermentation medium is preferably comprised between 20° C. and 40° C., more preferably between 25° C. and 35°.

In the present application, the crude reaction product obtained at the end of the fermentation process is called the crude fermentation product.

The crude fermentation product generally comprises at least two di-acylated MELs, at least the residual carbon-containing substrate and/or a by-product of the carbon-containing substrate, the strain and water, the by-product of the carbon-containing substrate resulting from the fermentation.

The step of collecting the MELs is directed to separating a MEL or the MELS from one or more of the other components of the crude fermentation product, such as the residual carbon-containing substrate and/or a by-product of the carbon-containing substrate, a strain, and/or water.

According to the above preferred embodiment, the crude fermentation product comprises at least two di-acylated MELs, at least one fatty acid and/or at least one fatty acid ester, water and a strain of the genus Pseudozyma.

The separation of a MEL or MELs from one or several of the other components of the crude fermentation product may be carried out by any separation method known to the person skilled in the art.

Advantageously, the separation of a MEL or MELs from one or more of the other components can comprise one or more of the following methods:
decanting,
centrifuging,
filtering,
evaporating,
performing liquid/liquid extraction,
passing over a mineral substrate or a resin.

In particular:
the strain may be separated by decanting, filtering, and/or centrifuging;
the water may be separated by decanting, evaporating, centrifuging, and/or passing over a mineral substrate that is an adsorbent;
the fatty acids and the fatty acid esters may be separated by performing liquid/liquid extraction and/or by passing over a mineral substrate or a resin. The collected MELs and thus the at least one MEL may thus comprise:
at least one fatty acid and/or at least fatty acid ester, and
optionally, water.

By “fatty acid” is meant a fatty acid that is free and/or in the form of a salt. The quantity of fatty acid(s) and/or fatty acid ester(s) present in the collected MELs may be comprised between 0.5 and 60% by weight, preferably between 0.5 and 55% by weight, relative to the total weight of the collected MELs. Advantageously, the fatty acid or fatty acids comprise a carbon chain comprising between 8 and 24 carbon atoms, preferably between 8 and 20 carbon atoms.

In the present application, all the ranges of values are understood to be inclusive. The collected MELs may thus be in a form that is purified to a greater or lesser degree, that is to say in a mixture with other components of the fermentation medium.

More particularly, in the present application, and in particular in the examples, when the collected MELs are in a mixture with at least one fatty acid and at least one fatty acid ester, optionally water, this mixture is called “MEL mixture”.

A first MEL mixture is a crude fermentation product, that is to say at least two di-acylated MELs with the other components of the crude fermentation product.

The crude fermentation product may be subjected to one or more separation methods, leading to other preferred MEL mixtures having the following features:
a total quantity of MELs greater than or equal to 30% by weight, preferably greater than or equal to 40% by weight;
a quantity of other components (among which fatty acid(s), fatty acid ester(s), and water) less than or equal to 70% by weight, preferably less than or equal to 60% by weight,
the percentages by weight being given relative to the weight of the MEL mixture. More particularly, according to the separation method or methods as described above, MEL mixtures of higher or lower MEL concentration may be obtained.

According to a first embodiment, the MEL mixture has the following features:
a total quantity of MELs greater than or equal to 40% by weight, preferably greater than or equal to 45% by weight;
a quantity of other compounds (among which fatty acid(s), fatty acid ester(s) and water) less than or equal to 60% by weight;
the percentages by weight being given relative to the weight of the MEL mixture. Advantageously, in this first embodiment, the quantity of water is less than or equal to 5% by weight, preferably less than or equal to 2% by weight, relative to the weight of the MEL mixture.

According to a second embodiment, the MEL mixture has the following features:
a total quantity of MELs greater than or equal to 90% by weight, preferably greater than or equal to 95% by weight;
a quantity of other components (among which fatty acid(s), fatty acid ester(s), and water) less than or equal to 10% by weight, preferably less than or equal to 5% by weight;
the percentages by weight being given relative to the weight of the MEL mixture. Advantageously, in this second embodiment, the quantity of water is less than or equal to 5% by weight, preferably less than 2% by weight, relative to the weight of the MEL mixture.

Such a MEL mixture may, for example, be obtained using a fermentation process such as described above, comprising several separation steps such as described above, these separation steps preferably including performing liquid/liquid extraction and/or passing over a mineral substrate.

The passage over a mineral substrate may be chromatography, such as adsorption chromatography with a silica column, carried out using suitable solvents. Such solvents are known to the person skilled in the art.

By “solvent” is meant a liquid under normal temperature and pressure (STP) conditions, which has the property of dissolving or diluting or extracting other substances without causing chemical change to those substances and without changing itself.

Examples of mixtures of MELs and of the process for obtaining them are also described in the following publication: “Downstream processing of mannosylerythritol lipids produced by Pseudozyma aphidis”; Rau et al.; European Journal of Lipids Science and Technology (2005), 107, 373-380. Advantageously, at least 80% by weight, preferably at least 85% by weight of the collected MEL or MELs further to the fermentation process described above are di-acylated.

As indicated above, there are several classes of MEL.

Advantageously, the concentrate according to the invention comprises at least two MELs coming from at least two different MEL classes chosen from among the group constituted by MELs-A, MELs-B, MELs-C and MELs-D.

According to a first advantageous embodiment, the MELs comprise MELs-A, MELs-B, MELs-C and optionally MELs-D, more preferably MELs-A, MELs-B, MELs-C and MELs-D.

Advantageously, the MELs comprise MELs-A and MELs-B in a total quantity comprised between 50% to 95% by weight, preferably 60% to 85% by weight, the percentages by weight being indicated relative to the weight of the total quantity of MELs.

By “total quantity” is meant the quantities of each enumerated compound.

Advantageously, the MELs comprise MEL-C and MELs-C in a quantity greater than or equal to 5% by weight, preferably greater than 10% by weight, the percentages by weight being indicated relative to the weight of the total quantity of MELs.

More particularly, the MELs comprise MELs-A and MELs-B in a total quantity comprised between 60% and 80% by weight and MELs-C in a quantity greater than or equal to 15% by weight, the percentages by weight being indicated relative to the weight of the total quantity of MELs.

According to a second advantageous embodiment, the MELs comprise MELs-D in a quantity comprised between 75% and 100% by weight, preferably between 90% and 100% by weight, the percentages by weight being indicated relative to the weight of the total quantity of MELs.

The MELs-D may be obtained by deacetylation of the MELs-A, MELs-B and MELs-C. An example of a deacetylation reaction of the MELs-A, MELs-B and MELs-C using a hydrolyzing enzyme is described in the following publication:

“Enzymatic synthesis of a novel glycolipid biosurfactant, mannosylerythritol lipid-D and its aqueous phase behavior”; Fukuoka et al.; Carbohydrate Research (2011), 346, 266-271.

Caprylic acid monoglyceride, the lipids of mannosylerythritol, and monopropylene glycol have the advantage of being unlabelled (no mention concerning possible risks is stated on the products) and biodegradable. The combination according to the invention thus has a good ecological profile.

As explained above, by “total quantity of caprylic acid monoglyceride and mannosylerythritol lipid(s)” is meant the sum of the quantity of monoglyceride and the total quantity of MEL(s).

By “total quantity of MEL(s)” is meant the total quantity of one or more different MELs represented by the chemical formula 1 or more particularly represented by the chemical formula 2, present in the combination.

Advantageously, in the combination according to the invention, the quantity of monopropylene glycol is at least 50% by weight relative to the weight of the combination.

Preferably, the quantity of monopropylene glycol is comprised between 50% and 80% by weight relative to the total weight of the combination.

The total quantity of mannosylerythritol lipid(s) in the combination according to the invention, is advantageously at least 0.3% by weight relative to the weight of the combination.

Preferably, the total quantity of mannosylerythritol lipid(s) in the combination according to the invention, is at least 0.4% by weight relative to the weight of the combination.

Preferably, the total quantity of mannosylerythritol lipid(s) is comprised between 0.3 and 8% by weight, more preferably between 0.4 and 5% by weight, still more preferably between 0.4 and 4% by weight, relative to the weight of the composition.

The quantity of caprylic acid monoglyceride in the combination according to the invention, is advantageously at least 15% by weight relative to the weight of the combination.

Preferably, the quantity of caprylic acid monoglyceride in the combination according to the invention, is at least 18% by weight relative to the weight of the combination.

Preferably, the total quantity of caprylic acid monoglyceride is comprised between 15 and 45% by weight, more preferably between 18 and 40% by weight, still more preferably between 18 and 35% by weight, relative to the weight of the composition.

Preferably, the ratio by weight of total quantity of caprylic acid monoglyceride and mannosylerythritol lipid(s) / MPG is at least ¼, more preferably at least 1/3.5.

When the combination according to the invention is added to water, it makes it possible to improve the wetting capacity of that water and the water is particularly well-absorbed by the soil (such as a solid peat surface), onto which it is applied. The effect of the combination according to the invention on the capacity of an aqueous solution to be absorbed by the soil is more fully described in Example 2.

The invention also relates to a process for preparing a combination according to the invention, comprising a step of mixing caprylic acid monoglyceride, at least one mannosylerythritol lipid with monopropylene glycol, and optionally a fatty acid and/or a fatty acid ester, the total quantity of caprylic acid monoglyceride and of mannosylerythritol lipid(s) being at least 20% by weight relative to the weight of the combination.

This mixing step is preferably carried out at ambient temperature and at atmospheric pressure.

Alternatively, the caprylic acid monoglyceride may be heated in advance to a temperature of at least 30° C., preferably at least 40° C. The heating of the components enables better and/or faster homogenization of the combination according to the invention.

Advantageously, the caprylic acid monoglyceride, the at least one mannosylerythritol lipid, the monopropylene glycol and the optional fatty acid and fatty acid ester, used in the process have preferred features and advantageous of these components as they are described above.

The invention also relates to a solution comprising a combination according to the invention, and water.

By “solution”, in the present application, is meant more particularly an aqueous solution, it being possible for this to be homogenous or not (for example, an emulsion, a dispersion or a suspension).

The combination and the constituents thereof are as described above, including the advantageous and preferred embodiments.

Preferably, the quantity of water is at least 50% by weight, more preferably, at least 70% by weight relative to the weight of the solution.

Advantageously, the quantity of combination according to the invention is at least 0.1% by weight relative to the weight of the solution.

Preferably, the quantity of the combination according to the invention in the solution according to the invention is at least 0.3% by weight, more preferably at least 0.5% by weight, more preferably still, at least 0.8% by weight relative to the weight of the solution.

Preferably, the quantity of combination according to the invention in the solution according to the invention is at most 15% by weight, more preferably at most 10% by weight, more preferably still, at most 5% by weight, relative to the weight of the solution.

The solution according to the invention may furthermore comprise a biostimulant and/or a pesticidal active ingredient.

Advantageously the solution according to the invention is thus a phytosanitary solution.

A biostimulant or defense stimulator for plants, is a fertilizer that stimulates the nutrition processes of plants independently of the nutritive components it contains, with the sole aim of improving one or more of the following characteristics of the plants:
the efficiency of use of the nutritive components,
the tolerance to abiotic stress,
the qualitative characteristics of the farmed plant.

The biostimulant may be selected from:
substances from living organisms, such as proteins, peptides, oligosaccharides and amino acids;
non-xenobiotic synthetic substances, such as tocopherols;
organic substances, such as humic and fulvic acids.

The person skilled in the art will know how to select the pesticidal active ingredient suitable for the desired use.

The pesticidal active ingredient is advantageously selected from herbicidal, fungicidal, insecticidal, nematicidal and/or acaricidal active ingredients. Preferably, the pesticidal active ingredient is a herbicidal active ingredient, a fungicidal active ingredient and/or an insecticidal active ingredient. Advantageously, the solution according to the invention comprises:
one or more fungicidal active ingredients such as a carboxamide, a strobilurin, an azole (triazole, imidazole), a heterocyclic compound (pyridine, pyrimidine, piperazine, morpholine), a carbamate, an essential oil (cinnamaldehyde, thymol, tea oil), a microorganism (fungi such as Gliocladium catenulatum and Trichoderma spp, yeast, bacteria such as Bacillus subtilis), a polysaccharide (chitosan) and/or,
one or more herbicidal active ingredients such as a lipid biosynthesis inhibitor, an acetolactase synthase inhibitor (also called “ALS inhibitor”), a photosynthesis inhibitor, an acetamide, an amino acid derivative such as an organophosphorus amino acid derivative (glufosinate or glyphosate) or their salts (glufosinate ammonium salts, monoor di-ammonium salts, salts of potassium, of glyphosate isopropylamine), an aryloxyphenoxypropionate, bipyridyl, cyclohexanedione, a dinitroaniline, diphenyl ether, hydroxybenzonitrile, imidazolinone, a phenoxyacetic acid, pyrazine, pirydine, a sulfonylurea, a triazine, a urea, a carbamate, a fatty acid with 6 to 10 carbon atoms (caprylic acid, pelargonic acid) or its derivatives (salts, soaps) and/or,
one or more insecticidal active ingredients such as an organo(thio)phosphate, a carbamate, a pyrethroid, an insect growth regulator, a nicotinic receptor agonist/antagonist, a GABA antagonist, a macrocyclic lactone, geraniol, eugenol, thymol, neem oil, 2-undecanone and/or,
one or more nematicidal active ingredients such as methyl pelargonate.

Furthermore, it will be noted that an active ingredient comprised in the solution according to the invention may have several of the following properties at the same time: herbicide, fungicide, insecticide, nematicide, acaricide and/or plant defense stimulator.

Advantageously, the pesticidal active ingredient is of renewable origin. Preferably, the pesticidal active ingredient is a bio-control active ingredient.

A bio control active ingredient is also called bio-pesticide active ingredient. Advantageously, the solution according to the invention comprises:
one or more biofungicidal active ingredients, such as a microorganism (fungi such as Gliocladium catenulatum and Trichoderma spp, yeast, bacteria such as Bacillus subtilis) and/or,
one or more bioherbicidal active ingredients, such as a fatty acid containing from 6 to 10 carbon atoms (caprylic acid, pelargonic acid) or its derivatives (salts, soaps) and/or,
one or more bionematicidal active ingredients such as methyl pelargonate, and/or,
one or more bioinsecticidal active ingredients, such as 2-undecanone.

Preferably the total quantity of pesticidal and/or biostimulant active ingredient is comprised between 0.1 and 30% by weight, preferably between 1 and 20% by weight, more preferably between 5 and 15% by weight relative to the total weight of the solution according to the invention.

By “total quantity of pesticidal and/or biostimulant active ingredient” is meant the total quantity of molecules of all the pesticidal and biostimulant active ingredients present in the solution according to the invention.

The invention also relates to a process for preparing a solution according to the invention, comprising a step of mixing a combination according to the invention, with water, and optionally a biostimulant and/or a pesticidal active ingredient. The solutions according to the invention are easy to prepare by simple mixing at ambient temperature.

The combination according to the invention and the constituents thereof are as described above, including the advantageous and preferred embodiments.

The invention furthermore relates to the use of a combination according to the invention, as a wetting agent.

More particularly, a combination according to the invention is used as a soil wetting agent.

The combination according to the invention indeed improves the absorption of water by the soil. The invention also relates to a method for improving the absorption of water by a soil, in particular persistently, by adding a combination according to the invention to water to form a solution, before placing said solution in contact with the soil.

As described above, a solution according to the invention comprising a combination according to the invention has a greatly improved soil wetting power. The water additivated with the combination according to the invention is not only better absorbed by the soil, that is to say the water is absorbed in greater quantities than water not additivated with the combination according to the invention, but subsequently, water is more easily absorbed by the soil during subsequent irrigations. It is as a matter of fact not necessary for the water to be additivated by the combination at each irrigation. The wetting effect remains effective front the at least 3, preferably at least 5, more preferably at least 9 following irrigations of the soil with water not additivated with the combination according to the invention, it being possible for the irrigations to be spaced apart with dry periods.

The invention thus furthermore concerns the use of a solution according to the invention in the irrigation of a soil.

The invention also relates to a method of irrigating a soil comprising a step of contacting the soil with a solution comprising the combination according to the invention and water.

The irrigation, or the contacting with an aqueous solution comprising the combination according to the invention, may be carried out by surface flow or by propulsion in the air in the form of droplets.

In the uses and methods according to the invention, the combination, the solution and their constituents thereof are as described above, including the advantageous and preferred embodiments.

### EXAMPLES

### Example 1: Preparation of Combinations According to the Invention

### 1. Obtaining MELs

The MELs were obtained by a fermentation process comprising the following steps:
the conversion of a carbon-containing substrate such as vegetable oil (rapeseed) with a strain of yeast such as Pseudozyma aphidis to obtain the MELs; and
collecting the MELs so obtained.

The step of collecting the MELs consisted of separating the MELs from the other constituents by filtration, centrifugation, liquid/liquid extraction and evaporation. Further to these various steps of separation, a first mixture comprising MELs (called “MELs mixture” 1A) was collected, which has the following features:
total quantity of MELs is 48% by weight (of which 42% by weight of di-acylated MELs and 6% by weight of tri-acylated MELs);
quantity of other components: 52% by weight (of which 38% by weight of fatty acid esters and 13% by weight of fatty acids);
the percentages by weight being given relative to the weight of the MEL mixture 1A collected.

An additional separation step applied to the MEL mixture 1A was next carried out by adsorption chromatography with a silica column. A second MEL mixture (called “MEL mixture” 1B) was thus collected, which has the following features:
total quantity of MELs is 95% by weight (of which 100% by weight of di-acylated MELs);
quantity of other components: 5% by weight (of which 3% by weight of fatty acids and 0.5% by weight of fatty acid esters);
the percentages by weight being given relative to the weight of the MEL mixture 1B collected.

### 2. Products Used

Caprylic acid monoglyceride (MG-C8), (Jolee 7907, Oleon);
mannosylerythritol lipids (MELs):
   MEL mixture 1A;
   MEL mixture 1B;
Monopropylene glycol (MPG) (Radianol 4713, Oleon);
Rapeseed fatty acids (rapeseed FA) (Radiacid 0166, Oleon)

### 3. Preparation of Combinations According to The Invention

Combinations 1 and 2 according to the invention were prepared by mixing, at ambient temperature, in a glass flask, the caprylic acid monoglyceride heated in advance to 60°, MEL mixture 1B, and monopropylene glycol. The combinations according to the invention thus obtained are limpid.

Combinations 3 to 6 according to the invention were prepared by mixing the various components as described above, using MEL mixture 1A. The presence of fatty acid esters in this MEL mixture required the addition of fatty acids to obtain limpid combinations.

The quantities of each component of the combinations, expressed in percentage by weight with respect to the total weight of the combination, are indicated in Table 1 below:

TABLE 1

| | MG-C8 (%) | MELs 1B (%) | MELs 1A (%) | Rapeseed FA (%) | MPG (%) |
|---|---|---|---|---|---|
| Combination 1 | 22 | 2.5 | - | - | 75.5 |
| Combination 2 | 27 | 2.5 | - | 4 | 66.5 |
| Combination 3 | 22 | - | 4.8 | 3.2 | 70 |
| Combination 4 | 32 | - | 7.7 | 5.1 | 55.2 |
| Combination 5 | 27 | - | 5 | 3 | 65 |
| Combination 6 | 32 | - | 1 | 0.6 | 66.4 |

### Example 2: Assessment of the Soil Wetting Power of the Solutions According to the Invention

### 1. Preparation of the Solutions According to the Invention

Solutions 1-6 according to the invention were prepared by introducing into a 2 L beaker, 1980 g of tap water and respectively 20 g of a combination 1-6 according to the invention prepared in Example 1. Which solution is mixed, using magnetic stirring, for 1 min at 400 rpm in order to obtain a homogenous dispersion of the combination in water.

Solutions 1-6 respectively contain 1% by weight of a combination 1-6.

### 2. Preparation of Reference Solutions 1-4

Reference solution 1 contains 500 g of tap water.

Reference solution 2 contains 0.92% of by weight of MPG in 99.08% tap water. Reference solution 3 contains 1% by weight of a mixture constituted by 27% by weight of MG-C8 and 73% by weight of MPG, in 99% of tap water.

Reference solution 4 contains 1% by weight of a mixture constituted by 5% by weight of MELs 1A, 3% by weight of Rapeseed FA and 92% by weight of MPG, in 99% of tap water.

### 3. Assessment of the Soil Wetting Power of the Solutions According to the Invention

### 3.1 Equipment

In addition to the solutions prepared earlier, peat tablets (Jilly-7® from Jiffy) composed of peat and maintained by a net of coconut fiber allowing air and water to pass, were used.

The height of a dry tablet is 0.8 cm and its diameter is 41 mm.

### 3.1.1 Hydrophobicity Test of the Peat Tablets

The hydrophobicity of the tablets was tested by measuring the Water Drop Penetration Time (WDPT):

a drop of tap water of 10 µL, taken with a VWR micropipette (0.5-10 µL) was deposited on the surface of a tablet. The stopwatch was set off at the same moment and stopped when the drop was no longer visible on the surface of the drop, in the present case after 150 s, corresponding to a strongly hydrophobic soil.

The publication “Water Repellency of Sieve Fractions from Sandy Soils and Relationships with Organic Material and Soil Structure”, Bisdom et al, Geoderma (1993), 56, 105-118, describes the classifications of a soil according to the water drop penetration time. Thus, five classes of soil were distinguished: wettable or non-hydrophobic (WDPT < 5 s), slightly hydrophobic (WDPT = 5-60 s), strongly hydrophobic (WDPT = 60-600 s), very strongly hydrophobic (WDPT = 600-3600 s), extremely hydrophobic (WDPT > 3600 s).

### 3.2 Immersion Tests

To evaluate the soil wetting power of solutions according to the invention and reference solutions, immersion tests of peat tablets were carried out.

### Step 1: Irrigation of the Peat with a Solution

500 g of a solution were weighed in a 1 L beaker placed on a balance (Mettler Toledo XS4002S). A skimmer was then placed in that beaker and the balance tared (reset to zero). A peat tablet was then deposited by hand on the surface of the solution. After 3 minutes, the tablet was removed using the skimmer, which was suspended for 10 seconds above the beaker in order for the non-absorbed water to drip off. The peat tablet was then deposited on a watch glass and the skimmer was placed back in the beaker. The mass displayed by the balance thus corresponds to the mass of water absorbed into peat tablet.

### Step 2: Drying Out the Peat

To simulate the drying out of the soil between two irrigations, the tablet, after 1 h of rest at ambient temperature, was disposed in an oven at 60° C. for 20 h.

### Step 3: New Irrigation With Water Not Additivated With a Combination According To the Invention or with any Other Compound

500 g of tap water were weighed in a 1 L beaker placed on a balance (Mettler Toledo XS4002S). A skimmer was then placed in that beaker and the balance tared (reset to zero).

After 1h of rest at ambient temperature on leaving the oven, the tablet was placed by hand on the surface of the water for 3 minutes and the mass of water absorbed was determined as described above in step 1.

Steps 2 and 3 were repeated 9 times in order to describe 9 irrigations carried out further to the first irrigation with a solution according to the invention (step 1). When the peat was immersed in a reference solution at the 1^{st} step, steps 2 and 3 were repeated only 5 times, the mass of water absorbed having already been divided by two between the 1^{st} and 2^{nd} immersion in water non additivated.

For each solution tested, the test was carried out three times. The quantities of water absorbed in 3 min, expressed in g, given in Table 2 and Table 3 constitute the average of the results of the three tests.

Comment: the volume of water absorbed by the 1^{st} immersion is less than the following volumes, since in 3 minutes the peat has not finished expanding and that expansion continues during the rest time. Also, for the following immersions, the tablet is completely expanded and the 3 minutes then suffice for the tablet to absorb a maximum volume of water.

TABLE 2

Immersions in water

| | | | | | | | | | | |
|---|---|---|---|---|---|---|---|---|---|---|
| | 1 | 2 | 3 | 4 | 5 | 6 | 7 | 8 | 9 | 10 |
| Solution 1 | 26.8 | 41.3 | 39.5 | 41.0 | 40.8 | 40.1 | 39.4 | 39.8 | 39.4 | 39.5 |
| Solution 2 | 25.5 | 41.5 | 39.3 | 40.7 | 37.5 | 35.7 | 35.9 | 33.6 | 35.8 | 38.7 |
| Solution 3 | 18.1 | 41.6 | 40.2 | 38.8 | 43.1 | 41.4 | 40.9 | 37.4 | 41.2 | 41.5 |
| Solution 4 | 20.5 | 43.0 | 39.9 | 39.4 | 42.1 | 42.1 | 40.6 | 37.1 | 41.1 | 41.7 |
| Solution 5 | 18.0 | 40.3 | 42.3 | 41.8 | 36.2 | 39.8 | 41.4 | 40.2 | 40.2 | 39.0 |
| Solution 6 | 24.9 | 42.9 | 40.5 | 36.8 | 38.8 | 35.2 | 36.8 | 34.3 | 37.1 | 39.6 |

TABLE 3

Immersions in water

| | | | | | | |
|---|---|---|---|---|---|---|
| | 1 | 2 | 3 | 4 | 5 | 6 |
| Reference solution 1 | 2.3 | 1.1 | 0.6 | 0 | - | - |
| Reference solution 2 | 7.6 | 8.7 | 4.0 | 2.2 | - | - |
| Reference solution 3 | 16.8 | 37.5 | 16.1 | 11.0 | 7.5 | 6.0 |
| Reference solution 4 | 9.9 | 20.3 | 10.0 | 5.7 | 5.6 | 1.7 |

The peats that have been in contact with a solution according to the invention, absorb greater quantities of water than peats never placed in contact with a combination according to the invention. Furthermore, at the immersions 2 to 10, constituting a placing in contact of the dry peats with non additivated water, the water absorption takes place in equivalent quantities, which shows the persistence of the wetting effect after a placing in contact of the combination according to the invention with the peat at the 1^{st} immersion.

The combinations according to the invention may thus be used as a soil wetting agent with a persistent effect.

Water alone (reference solution 1) is only weakly absorbed by the dry peat.

It may also be noted that MPG alone (reference solution 2), and 5% MELs A1 mixture in fatty acid and MPG (reference solution 4), do not enable water to be absorbed in large quantity in a dry peat.

The caprylic acid monoglyceride in MPG (reference solution 3) facilitates the absorption of water at the 1^{st} additivated irrigation and at the following non additivated irrigation, the quantities of water absorbed being however less than the quantities of water absorbed at the time of immersions in solutions according to the invention. There is however no long persistent effect, the mass of water absorbed at the 3^{rd} immersion is equivalent to half of the mass of water absorbed at the 2^{nd} irrigation.

1. A combination comprising or consisting of:
caprylic acid monoglyceride;
at least one mannosylerythritol lipid;
monopropylene glycol; and
optionally a fatty acid and/or a fatty acid ester;
wherein the total quantity of caprylic acid monoglyceride and mannosylerythritol lipid(s) is at least 20% by weight relative to the weight of the combination.

2. The combination according to claim 1, wherein the quantity of monopropylene glycol is at least 50% by weight relative to the weight of the combination.

3. The combination according to claim 1, wherein the total quantity of mannosylerythritol lipid(s) is at least 0.3% by weight relative to the weight of the combination.

4. The combination according to claim 1, wherein the quantity of caprylic acid monoglyceride is at least 15% by weight relative to the weight of the combination.

5. A process for preparing a combination according to claim 1, comprising a step of mixing caprylic acid monoglyceride, at least one mannosylerythritol lipid with monopropylene glycol, and optionally a fatty acid and/or a fatty acid ester, the total quantity of caprylic acid monoglyceride and of mannosylerythritol lipid(s) being at least 20% by weight relative to the weight of the combination.

6. A solution comprising a combination according to claim 1 and water.

7. A solution comprising a combination according to claim 1 and water, wherein the quantity of the combination is at least 0.1% by weight relative to the weight of the solution.

8. The solution according to claim 6, further comprising: a biostimulant and/or a pesticidal active ingredient.

9. A process for preparing a solution comprising a step of mixing a combination according to claim 1 with water, and optionally a biostimulant and/or a pesticidal active ingredient.

10. A wetting agent comprising a combination according to claim 1.

11. A method of irrigating a soil comprising contacting the soil with a solution according to claim 6.
